(19) United States
(12) Patent Application Publication
(10) Pub. No.: US 2008/0317176 A1
(43) Pub. Date: Dec. 25, 2008

(54) Automatic Gain Control Apparatus and Method in Wireless Telecommunication System

(75) Inventor: Ji-myung Oh, Gyeonggi-do (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: POSTDATA CO., LTD., Seongnam-si (KR)

(21) Appl. No.: 12/158,306

(22) PCT Filed: Dec. 28, 2006
(86) PCT No.: PCT/KR2006/005796

§ 371 Date: Jun. 19, 2008

(30) Foreign Application Priority Data
Dec. 30, 2005 (KR) 10-2005-0135232

(51) Int. Cl. H04L 27/06

(52) U.S. Cl. 375/345

(57) ABSTRACT

The present invention relates to an automatic gain control apparatus and method in a wireless telecommunication system which measures the strength of received signals using preamble symbols and automatically control the gain of an amplifier based on the measurement results. The automatic gain control apparatus and method according to present invention performs automatic gain control of measuring sample power in a sample unit for input signals, acquiring a sample power average value during a unit symbol period, detecting a maximum value during one frame period for the acquired sample power average value and then calculating a gain control value based on it.

### TECHNICAL FIELD

The present invention relates generally to an automatic gain control apparatus and method in a wireless telecommunication system and, more particularly, to an automatic gain control apparatus and method in a wireless telecommunication system which measures the strength of received signals using preamble symbols and automatically controls the gain of an amplifier based on the measurement results so as to be applicable in a portable internet system.

### BACKGROUND ART

Generally, in a wireless telecommunication system, there is a characteristic that the strength of input signals is not uniformly maintained and varies within a specified range because of the variation in distance between a Radio Access Station (RAS) and a Portable Subscriber Station (PSS), an interference caused by obstacles, the movement of a PSS, and the variation in environment of a PSS. In this case, in order to uniformly maintain the strength of signals transmitted to the baseband demodulator of the PSS, the RF (Radio Frequency)/IF (Intermediate Frequency) module thereof uses an amplifier, the gain of which is controllable. In this case, the control of the gain is accomplished by measuring the strength of current input signals and determining a gain control value based on the measurement in the RF/IF module or the baseband de-modulator.

The construction of the conventional automatic gain control apparatus of a wireless telecommunication system is schematically described below with reference to FIG. 1. Signals received via an antenna are delivered to a baseband demodulator through RF/IF components such as a Low Noise Amplifier (LNA) and a Gain Controlled Amplifier (GCA), an Analog to Digital Converter (ADC), a matched filter, a decimator. Furthermore, signals outputted from the decimator are inputted again into an Automatic Gain Control (AGC) module for automatic gain control. The automatic gain control module measures the strength of input signals and determines a gain control value. The gain control value is inputted again to the LNA and the GCA through an RF/IF interface, thereby forming an automatic gain control loop. Furthermore, such an automatic gain control loop may be mainly divided into analog parts including the low noise amplifier, the gain controlled amplifier, the analog to digital converter, and digital parts including the matched filter, the decimator, the automatic gain control module and the RF/IF interface.

However, in the automatic gain control technology according to related art applied to a time-division wireless telecommunication system (for example, time-division portable internet system), a sample period which is used to calculate the strength of input signals is important. Because, in the related art, the sample period is determined within a downlink (DL) frame and the strength of input signal is varied according to a each symbol constituting the DL frame. Especially, when synchronization has not been accomplished at the beginning of operation of the PSS, the variation of the strength of input signal may cause serious problems.

### DISCLOSURE OF INVENTION

### Technical Problem

Accordingly, the present invention has been made keeping in mind the above problems occurring in the related art, and an object of the present invention is to provide an automatic gain control apparatus and method in a wireless telecommunication system, capable of measuring the strength of received signals using preamble symbols and automatically controlling the gain of an amplifier according to the measurement result.

Another object of the present invention is to provide an automatic gain control apparatus and method in a wireless telecommunication system, which can easily detect preamble symbols using an AGC mode selection signal, which is determined by whether frame synchronization has been accomplished, and a preamble end timing signal upon automatic gain control.

Further object of the present invention is to provide automatic gain control apparatus and method in a wireless telecommunication system, which can easily calculate an optimal gain control value using AGC Read Only Memory (ROM) in which gain control value data, which are measured and calculated in advance, are embedded in a ROM table when an automatic gain control module calculates a gain control value for the strength of input signals.

### Technical Solution

In order to accomplish the above objects, the present invention provides an automatic gain control apparatus in a wireless telecommunication system, including a gain control amplifier for performing gain control on input signals received from an antenna; an analog to digital converter for converting analog signals outputted from the gain control amplifier into digital signals; a matched filter for filtering the digital signals outputted from the analog to digital converter to improve a signal-to-noise ratio; a decimator for re-sampling the over-sampled digital signals outputted from the matched filter; an automatic gain control module for measuring sample power for samples outputted from the decimator, calculating a sample power average value for an unit symbol period, and calculating a gain control value based on a maximum value or preamble symbol power from the sample power average values calculated within one frame period; and an RF/IF interface for transmitting the gain control value determined by the automatic gain control module to the gain control amplifier.

Additionally, the present invention provides an automatic gain control module of a wireless telecommunication system, including a sample power measurement unit for measuring sample power in sample unit for input signals; a moving averaging unit for calculating a sample power average value for a predetermined period for the sample; a peak detector for detecting a maximum value for one frame period for the sample power average values; and a gain control value calculator for calculating a gain control value based on the sample power average value.

Preferably, the automatic gain control module further includes a timing controller for providing transmitting an AGC mode selection signal indicating whether frame synchronization is accomplished as an input of the gain control value calculator. The automatic gain control module calculates the gain control value based on the maximum value of the sample power average value when it is determined that frame synchronization has not been accomplished, and calculates the gain control value based on a value corresponding a preamble end timing set position among the sample power average values outputted from the moving averaging unit when it is determined that frame synchronization has been accomplished.

According to an aspect of the present invention, there is provided an automatic gain control method of a wireless telecommunication system, comprising the steps of: a) converting analog signals received from an antenna into digital signals; b) filtering the digital signals to improve a signal-to-noise ratio; c) re-sampling the over-sampled digital signals; d) measuring sample power for the re-sampled samples and then calculating a sample power average value for a unit symbol period; e) calculating a gain control value based on a maximum value detected for one frame period among the sample power average values; and f) performing gain control on analog signals received from the antenna based on the calculated gain control value.

According to another aspect of the present invention, there is provided an automatic gain control method in a wireless telecommunication system, comprising the steps of: a) measuring sample power in a sample unit for input signals; b) calculating a sample power average value during a unit symbol period for the samples; c) calculating a gain control value based on the sample power average value; and d) performing gain control based on the gain control value.

### ADVANTAGEOUS EFFECTS

The present invention is advantageous to resolve a problem related with a measurement period which may occur in a time-division system, thereby having an optimal automatic gain control is performed when, in a wireless telecommunication system, in particular, a portable internet system, automatic gain control is performed.

Furthermore, the present invention measures the strength of input signals for a period corresponding to an preamble symbol even at the beginning of operation of a Portable Subscriber Station (PSS) before frame synchronization has been accomplished, applies the strength of input signals to the calculation of a gain control value, thereby having an advantage in that optimal automatic gain control is performed regardless of whether frame synchronization has been accomplished.

Furthermore, according to the present invention, the gain control value is easily acquired by determining the input address of the ROM according to the strength of the input signal (sample power average value) and using the output of the ROM as a gain control value, wherein the ROM has stored the gain control value data which are measured and calculated as a ROM table in advance, the gain control value data corresponding to the strength of input signals.

### BRIEF DESCRIPTION OF THE DRAWINGS

FIG. 1 is a schematic diagram illustrating an automatic gain control apparatus in a wireless telecommunication system;

FIG. 2 is a diagram illustrating the construction of the automatic gain control apparatus in the wireless telecommunication system according to the present invention in detail;

FIG. 3 is a diagram illustrating the structure of frame useable in the present invention;

FIG. 4 is a diagram illustrating another construction of the automatic gain control apparatus in the wireless telecommunication system according to the present invention in detail; and

FIG. 5 is a flowchart illustrating the automatic gain control method in the wireless telecommunication system according to the present invention.

### MODE FOR THE INVENTION

Hereinafter, an exemplary embodiment of the present invention will be described in detail with reference to the accompanying drawings. Well known functions and constructions are not described in detail since they would obscure the invention in unnecessary detail.

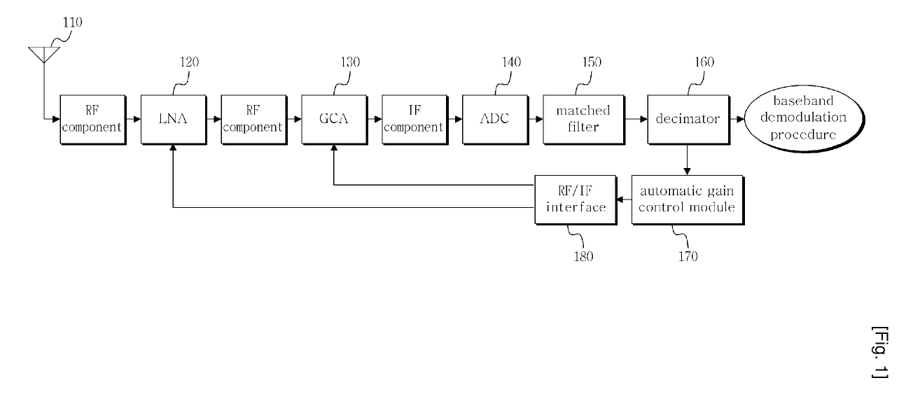

The construction of the automatic gain control apparatus of a wireless telecommunication system associated with the present invention is schematically described below with reference to FIG. 1.

Signals which are received through an antenna 110 pass through RF components, and transmitted to a Low Noise Amplifier (LNA) 120. The LNA 120 is an amplifier for minimizing noise that is generated in a Portable Subscriber Station (PSS), while it is the first amplifier located on a reception path.

The signals, amplified by the LNA 120, pass through the RF components and are then inputted to a Gain Control Amplifier (GCA) 130, which is an amplifier for performing a gain control function by amplifying the input signals. Meanwhile, the signals, amplified by the GCA 130 pass through IF components and are then inputted to an Analog to Digital Converter (ADC) 140, in which the analog signals are converted into digital signals.

The signals which are converted into the digital signals by ADC 140 are inputted to a matched filter 150, which is a low pass filter providing a optimal Signal-to-Noise Ratio (SNR) for the received signals. The signals filtered by the matched filter 150 are inputted to a decimator 160, which performs re-sampling on over-sampled signals.

The signals passed through the decimator 160 undergo a baseband demodulation process and are simultaneously inputted to an automatic gain control module for automatic gain control.

For reference, the RF components and the IF components, described in this specification with reference to FIG. 1, collectively represent RF/IF elements, such as various types of switches, filters, demodulators, etc., which are less associated with the present invention, and thus are represented by one integrated block, thereby omitting the descriptions thereof.

In the automatic gain control module, the measurement of the strength of input signals and the determination of a gain control value which are the most important operations are performed. In this embodiment, the input signals refer to signals sequentially passed through the analog-to-digital converter, the matched filter, and the decimator.

The gain control value determined by the automatic gain control module is appropriately divided and delivered to the low noise amplifier and the gain control amplifier via an RF/IF interface.

That is, the automatic gain control module measures the sample power of signals input through the decimator at each sample timing, averages sample power for predetermined period, and measures the strength of the input signals. Furthermore, the acquired strength of the input signals is compared with the strength of predetermined input signals (strength of reference input signals), and the gain control value is adjusted to compensate for the difference between the acquired strength of the input signals and the strength of predetermined input signal. Finally, the RF/IF interface is the interface for transmitting the control results determined by the automatic gain control module to the RF/IF module.

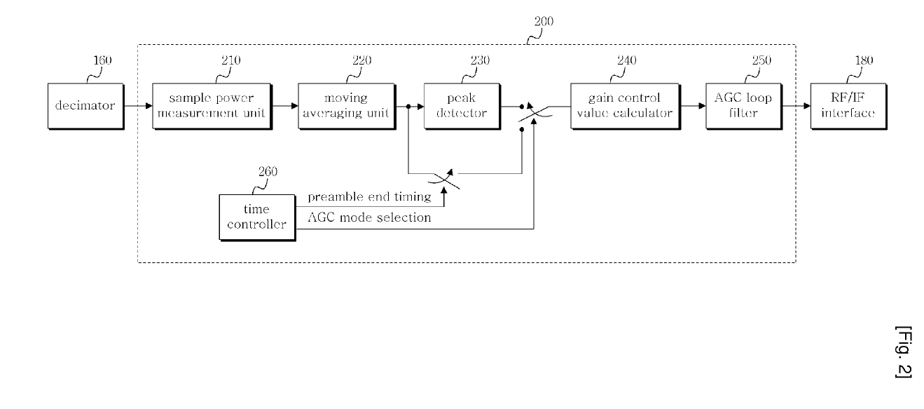

The automatic gain control apparatus and method are described in detail with reference to FIGS. 2 to 5.

FIG. 2 is a diagram illustrating the construction of the automatic gain control apparatus in the wireless telecommunication system according to the present invention in detail.

The automatic gain control module 200 shown in FIG. 2 corresponds to the automatic gain control module 170 which is shown in FIG. 1 to describe the general structure of an automatic gain control apparatus and includes specific elements for implementing the present invention. For reference, the automatic gain control module 200 of FIG. 2 is designated by reference number 200 to distinguish the automatic gain control module 200 from the automatic gain control module 170 of FIG. 1.

The automatic gain control module 200 according to the present invention mainly includes a sample power calculator 210, a moving averaging unit 220, a peak detector 230, an automatic gain control value calculator 240, and an AGC loop filter 250.

The sample power calculator 210 calculates instant sample power for input signals in a sample unit which are received through the decimator 160 at step S510. For example, when the input signals of the sample power calculator 210 are r_{I}(n), and r_{Q}(n), the output thereof is the following Equation 1.

E(n)={r_{I}²(n)+r_{Q}²(n)} [Equation 1]

Where r_{I}(n) is the in-phase signal of an n-th sample, and r_{Q}(n) is the quadrature-phase signal of an n-th sample.

The moving averaging unit 220 calculates a sample power average value for a predetermined period from a current sample time point at step S520. In this case, the accumulated period for calculation of the average value is set “a unit symbol period”.

The reason why the accumulated period is set to have a length identical to that of the unit symbol period is to use only period corresponding to a preamble symbol in order to measure the strength of input signals, which is one of the principal technical characteristics of the present invention. If a preamble is composed of two or more symbols, the accumulation period may be set to the unit symbol period, or, alternatively, may be implemented to be identical to that of symbols constituting a preamble.

If the accumulation period is set to be identical to the length of the period (that is, n multiple of a unit symbol period, where n is integer of 2 or larger) of symbols constituting a preamble, automatic gain control can be performed more accurately than to be the unit symbol period.

If it is assumed that Equation 1 is the input of the moving averaging unit 220, the output thereof is the following Equation 2.

$${E}_{RSSI} = {\sum }_{n = 0}^{N - 1} E ( n - k ) = {\sum }_{n = 0}^{N - 1} \{ {r}_{I}^{2} ( n - k ) + {r}_{Q}^{2} ( n - k ) \} \qquad [ Equation 2 ]$$

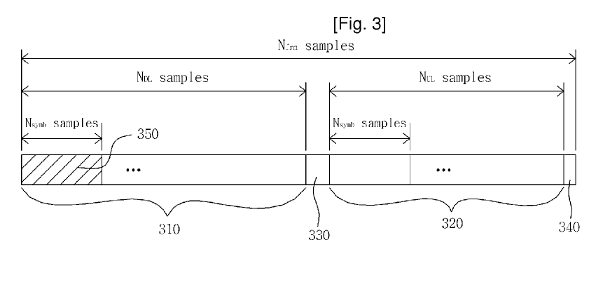

The structure of frame useable in a portable internet system adopting time-division duplexing is schematically described with reference to FIG. 3.

According to time-division duplexing scheme, one frame is divided into a part for transmission and a part for reception in time-division transmission scheme which are then used.

As illustrated in FIG. 3, one frame is divided into a downlink frame 310 and an uplink frame 320 and, thus bi-directional communication is performed using one frequency.

One frame is composed of a plurality of samples. In FIG. 3, it is shown that one frame is composed of N_{frm} samples, the downlink frame 310 is composed of N_{DL} samples, and the uplink frame 320 is composed of N_{UL} samples.

Furthermore, there is a Transmit/receive Transition Gap (TTG) 330 between the downlink frame 310 and the uplink frame 320, and a Receive/transmit Transition Gap (RTG) 340 exists in the last of the frame to distinguish a current uplink frame 320 from a subsequent downlink frame 310. Meanwhile, in the downlink frame 310 and the uplink frame 320, N_{symb} samples constitute one symbol, and, in this point of view, one frame is composed of a plurality of symbols.

In a portable internet system, a first symbol 350 of a downlink frame is a preamble, a specific Pseudo Noise (PN) random code is modulated using Binary Phase Shift Keying (BPSK) on a frequency axis and transmitted. The preamble symbol is used for initial synchronization, cell searching, frequency offset and the estimation of a channel, etc.

Generally, the transmission power of the preamble signal of all symbols is largest. In the case of symbols except for the preamble symbol, the strength of input signals varies depending on the amount of data assigned to a Radio Access Station (RAS), and thus they are unsuitable to be used as a factor for automatic gain control.

Therefore, the present invention easily detects the preamble symbol by setting an accumulation period to the unit symbol period upon calculation of a sample power average value and uses only a period corresponding to the detected preamble symbols in order to measure the strength of input signals.

Referring to FIG. 2 again, the sample power average value calculated by the moving averaging unit 220 is input to the peak detector 230. In this case, a maximum sample power average value is detected and is then used for automatic gain control. In detail, during the beginning of the operation of a PSS, the position of the preamble can not be known before the frame synchronization has been accomplished. The peak detector 230 detects a time point at which the average value of the strength of input signals measured during a symbol period (sample power average value) is largest within one frame period and assumes that this value is a value corresponding to the preamble symbol.

If it is assumed that Equation 2 is the input of the peak detector 230, the output thereof is the following Equation 3.

Eₘₐₓ=Max[E_{RSSI}(k)] [Equation 3]

Meanwhile, there is no need to use the peak detector 230 after the frame synchronization of a PSS has been accomplished, and a value corresponding to a preamble end timing set position is used for automatic gain control among resulted sample power average values.

For this purpose, the automatic gain control module of the present invention controls signals input to the gain control value calculator 240 using the AGC mode selection signal. For example, when frame synchronization has not been accomplished, the preamble end timing can not be known. Therefore the AGC mode selection signal is set to ‘0’ in step S530, and the sample power average value outputted from the moving averaging unit is switched so as to pass through the peak detector 230 and be input to the gain control value calculator 240 in step S540.

In contrary, when frame synchronization has been accomplished, the preamble end timing can be known. Therefore the AGC mode selection signal is set to ‘1’ in step S530, at this time the peak detector 230 and the gain control value calculator 240 are opened and a value corresponding to a position set to preamble end timing among sample power average values outputted from the moving averaging unit is switched so as to be input to the gain control value calculator 240 in step S550.

FIG. 2 illustrates a case in which a switch is located between the peak detector 230 and the gain control value calculator 240, thereby performing switching based on an AGC mode selection signal outputted from the timing controller 260.

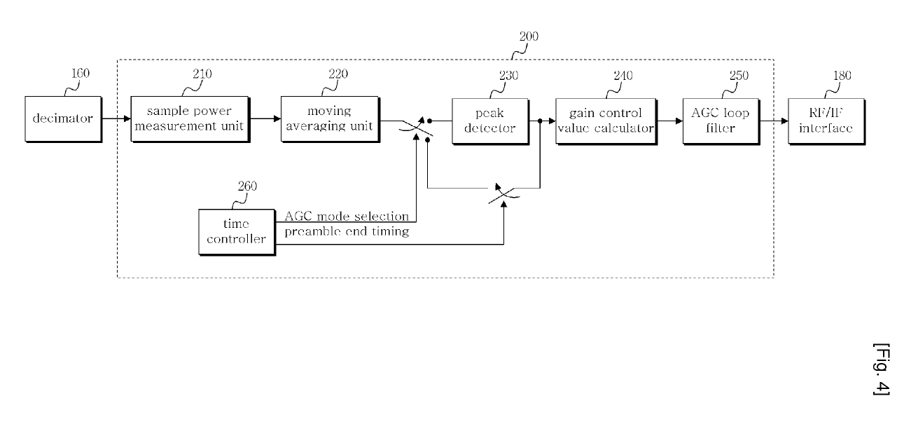

Meanwhile, as illustrated in FIG. 4, the switch controlled by the AGC mode selection signal is implemented to be located between the moving averaging unit 220 and the peak detector 230. Of course, in this case, the output of the peak detector 230 may be ‘0’ or the peak detector 230 and the gain control value calculator 240 may be implemented to be open.

The AGC mode selection signal and the preamble end timing signal indicating whether frame synchronization has been accomplished are outputted from a timing controller 260. The timing controller 260 used in the present invention is a controller for outputting the AGC mode selection signal and the preamble end timing signal.

Although the timing controller 260 is illustrated to be included in the automatic gain control module 200 in FIGS. 2 and 4, it is not necessary to be included within the automatic gain control module. In other words, the timing controller 260 may be implemented using a controller for controlling all timing signals of a PSS. Furthermore, the AGC mode selection signal and/or the preamble end timing signal are not always output directly from one timing controller 260, and may be output indirectly from other components or logical elements.

The gain control value calculator 240 calculates a gain control value based on the sample power average value outputted from the peak detector 230 or the moving averaging unit 220 at step S560. Preferably, the gain control value calculator 240 can be embodied in a ROM. In this case, the gain control value calculator 240 has stored the gain control value data which are measured and calculated as a ROM table in advance, the gain control value data corresponding to strength of input signals. When an input address of the ROM is determined by the strength of the measured input signal (sample power average value), the gain control value is output from the ROM corresponding to the strength of the input signal. Thereby the gain control value can be easily acquired.

Meanwhile, in the case in which the automatic gain control result value (gain control value) determined in any frame is used by being directly applied to a subsequent frame, over-damping phenomenon may occur, thereby affecting performance adversely.

Therefore, in order to prevent it, the present invention applies the output which passed through the AGC loop filter 250, to the subsequent frame, rather than applies the gain control value outputted from the gain control value calculator 240 to the subsequent frame directly. That is, the AGC loop filter 250 uses a specific loop gain to set an appropriate loop bandwidth, determining the adaptation speed of an automatic gain control loop.

The output of the AGC loop filter 250 passes through the RF/IF interface 180 and then is input the low noise amplifier 120 and/or the gain control amplifier 130, thereby accomplishing automatic gain control.

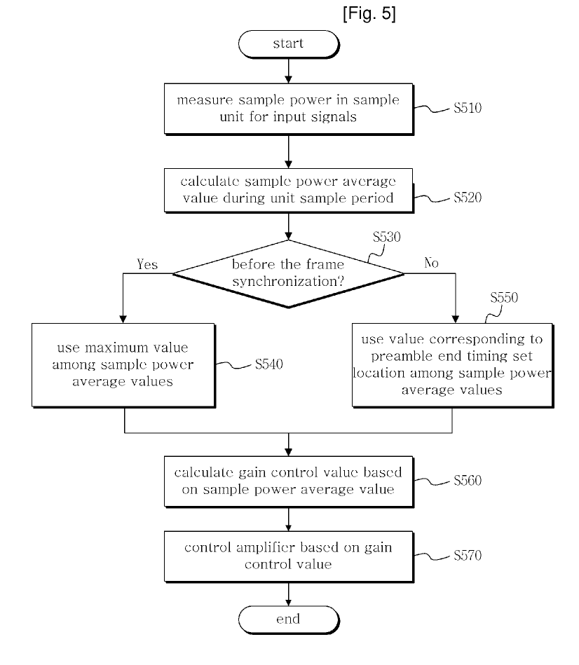

Finally, FIG. 5 is a flowchart illustrating an automatic gain control method of in a wireless telecommunication system according to the present invention.

The automatic gain control method of the wireless telecommunication system according to the present invention has been described in detail with reference to FIGS. 2 to 4, so that part related with FIG. 5 is only described in detail below.

The flowchart illustrated in FIG. 5 shows a procedure performed by the automatic gain control module of all procedures of automatic gain control of the wireless communication system.

First, in step S510, sample power is measured in sample unit per sample timing for input signals. Thereafter, in step S520, a sample power average value for samples in unit symbol period back from a point of current time is calculated.

The acquired sample power average value is the basis for the calculation of the gain control value. In this case, a power average value of specific samples (in detail, a sample power average value corresponding to a preamble symbol period) is only used for the calculation of the gain control value rather than a power average value for all samples.

In this case, depending on whether frame synchronization has been accomplished, the detection method thereof varies, and whether frame synchronization has been accomplished can be known by signals input from the timing controller.

In step S530, whether frame synchronization has been accomplished is determined. Before frame synchronization has been accomplished, the preamble symbol period can not be known, so that the procedure proceeds to step S540, and then a maximum value of sample power average values is used for the calculation of the gain control value. In contrast, after frame synchronization has been accomplished, the preamble symbol period can be known, so that the procedure proceeds to step S550, and then a value corresponding to the preamble end timing set position from sample power average values is used for the calculation of the gain control value.

In step S560, the gain control value is calculated by determining the input address of the ROM according to the strength of the input signal (sample power average value) and using the output of the ROM as a gain control value, wherein the ROM has stored the gain control value data which are measured and calculated as a ROM table in advance, the gain control value data corresponding to the strength of input signals.

Finally, in step S570, the gain of an amplifier is controlled based on the calculated gain control value, thereby performing automatic gain control.

The procedure of automatic gain control illustrated in FIG. 5 may be performed based on the procedure performed by the automatic gain control module which is described with reference to FIGS. 2 to 4. Of cause, the above-described steps do not need to be necessarily performed by the sample power measurement unit, moving averaging unit, peak detector, gain control value calculator of an automatic gain control module.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. An automatic gain control apparatus in a wireless telecommunication system, comprising:
gain control amplifier for performing gain control on input signals received via an antenna;
analog to digital converter for converting analog signals outputted from the gain control amplifier into digital signals;
matched filter for filtering the digital signals outputted from the analog to digital converter to improve a signal-to-noise ratio;
decimator for re-sampling the over-sampled digital signals outputted from the matched filter;
automatic gain control module for measuring sample power for samples outputted from the decimator, calculating a sample power average value for an unit symbol period, and calculating a gain control value based on a maximum value from the sample power average values calculated within one frame period; and
RF/IF interface for transmitting the gain control value determined by the automatic gain control module to the gain control amplifier.

2. The automatic gain control apparatus as claimed in claim 1, further comprising a timing controller for transmitting an Automatic Gain Control (AGC) mode selection signal indicating whether frame synchronization is accomplished to the automatic gain control module, and
wherein the automatic gain control module calculates the gain control value based on a maximum value of the sample power average values when it is determined that frame synchronization has not been accomplished based on the AGC mode selection signal, and calculates the gain control value based on a value corresponding a preamble end timing set position among the sample power average values when it is determined that frame synchronization has been accomplished based on the AGC mode selection signal.

3. The automatic gain control apparatus as claimed in claim 1, further comprising a low noise amplifier for decreasing noise of the input signals received from the antenna and transmitting the signals to the gain control amplifier, and wherein the RF/IF interface transmits the gain control value to the low noise amplifier.

4. The automatic gain control apparatus as claimed in claim 1, wherein the unit symbol period is identical to a preamble symbol period.

5. The automatic gain control apparatus as claimed in claim 1, wherein the wireless telecommunication system is a portable internet system using at least one of an Orthogonal Frequency Division Multiple Access (OFDMA) scheme and a Time-Division Duplexing (TDD) scheme.

6. An automatic gain control module of a wireless telecommunication system, comprising:
sample power measurement unit for measuring sample power in sample unit for input signals;
moving averaging unit for calculating a sample power average value for a predetermined period for the sample;
peak detector for detecting a maximum value for one frame period for the sample power average values; and
gain control value calculator for calculating a gain control value based on the sample power average value.

7. The automatic gain control module as claimed in claim 6, further comprising a timing controller for providing an AGC mode selection signal based on to the frame synchronization as an input of the gain control value calculator, wherein the gain control value calculator is switched depending on the AGC mode selection signal, calculates the gain control value based on the sample power average value outputted from the peak detector when it is determined that frame synchronization has not been accomplished, and calculates the gain control value based on a value corresponding a preamble end timing set position among the sample power average values outputted from the moving averaging unit when it is determined that frame synchronization has been accomplished.

8. The automatic gain control module as claimed in claim 6, further comprising a timing controller for providing an AGC mode selection signal based on the frame synchronization as an input of the peak detector,
wherein the peak detector is switched depending on the AGC mode selection signal, transmits the detected maximum value of the sample power average values to the gain control value calculator when it is determined that frame synchronization has not been accomplished, and does not transmit an output signal to the gain control value calculator when it is determined that frame synchronization has been accomplished.

9. The automatic gain control module as claimed in claim 6, further comprising an AGC loop filter for applying the calculated gain control value to a predetermined loop gain to set a loop bandwidth, thereby determining the adaptation speed of the automatic gain control loop.

10. The automatic gain control module as claimed in claim 6, wherein the predetermined period is n multiple of a unit symbol period, and the n is natural number.

11. The automatic gain control module as claimed in claim 6, wherein the predetermined period is identical to a preamble symbol period.

12. The automatic gain control module as claimed in claim 6, wherein the gain control value calculator is Read Only Memory (ROM), an input address of which is the sample power average value and an output value of which is the gain control value.

13. An automatic gain control method of a wireless telecommunication system, comprising the steps of:
a) converting analog signals received via an antenna into digital signals;
b) filtering the digital signals to improve a signal-to-noise ratio;
c) re-sampling the over-sampled digital signals;
d) measuring sample power for the re-sampled samples and then calculating a sample power average value for a unit symbol period;
e) calculating a gain control value based on a maximum value detected for one frame period among the sample power average values; and
f) performing gain control on received analog signals based on the calculated gain control value.

14. The method as claimed in claim 13, wherein the step f) performs gain control by controlling a low noise amplifier for decreasing noise of the received analog signals.

15. The method as claimed in claim 13, wherein the unit symbol period is identical to a preamble symbol period.

16. The method as claimed in claim 13, wherein the wireless telecommunication system is a portable internet system using at least one of an Orthogonal Frequency Division Multiple Access (OFDMA) scheme and a Time-Division Duplexing (TDD) scheme.

17. An automatic gain control method in a wireless telecommunication system, comprising the steps of:
a) measuring sample power in a sample unit for input signals;
b) calculating a sample power average value during a unit symbol period for the samples;
c) calculating a gain control value based on the sample power average value; and
d) performing gain control based on the gain control value.

18. The method as claimed in claim 17, wherein the step c) comprises the steps of:
c-1) calculating the gain control value based on a maximum value detected within a one frame period among the sample power average values before the frame synchronization; and
c-2) calculating the gain control value based on a value corresponding to a preamble end timing set position among the sample power average values after the frame synchronization.

19. The method as claimed in claim 18, wherein, in the step c), the determination of the frame synchronization is performed by an AGC mode selection signal transmitted from a timing controller.

20. The method as claimed in claim 17, wherein the step d) comprises the step of determining adaptation speed of an automatic gain control loop by applying the gain control value to a predetermined loop to set a loop bandwidth.

21. The method as claimed in claim 17, wherein the unit symbol period is identical to a preamble symbol period.
